(19) United States
(12) Patent Application Publication
(10) Pub. No.: US 2017/0009360 A1
(43) Pub. Date: Jan. 12, 2017

(54) ELECTRODEPOSITED CURRENT COLLECTORS

(71) Applicant: Xtalic Corporation, Marlborough, MA (US)

(72) Inventors: Christopher A. Schuh, Wayland, MA (US); Alan C. Lund, Framingham, MA (US)

(73) Assignee: Xtalic Corporation, Marlborough, MA (US)

(21) Appl. No.: 15/093,837

(22) Filed: Apr. 8, 2016

Related U.S. Application Data
(60) Provisional application No. 62/144,743, filed on Apr. 8, 2015.

(51) Int. Cl. C25D 1/20; H01M 10/0525; H01M 4/66; C25D 3/44; C25D 3/56

(52) U.S. Cl. CPC C25D 1/20; C25D 3/44; C25D 3/56; H01M 4/661; H01M 4/662; H01M 10/0525

(57) ABSTRACT

Embodiments of electrodeposited current collectors and their methods of use and manufacturer described. For example, in one embodiment, an electrochemical power cell includes an anode including a first current collector and an anode active material deposited on the first current collector. The electrochemical power cell also includes a cathode including a second current collector and a cathode active material deposited on the second current collector. At least one of the first current collector and the second current collector is an electrodeposited aluminum foil. In another embodiment, a current collector includes a free standing foil made from electrodeposited aluminum.

### RELATED APPLICATIONS

This application claims priority to U.S. Provisional Application No. 62/144,743, filed Apr. 8, 2015, which is incorporated herein by reference in its entirety.

### FIELD

Disclosed embodiments are related to electrodeposited current collectors.

### BACKGROUND

Many batteries including, for example, lithium-ion batteries, include current collectors such as an aluminum cathode current collector and a copper or aluminum anode current collector. These current collectors are used to transfer current from the electrochemical materials deposited on the current collectors to an outside circuit. The current collectors serve a dual purpose in that they are used to transport this current, but are also used to support the electrochemical materials located within the cell particularly during cell manufacturing.

### SUMMARY

In one embodiment, an electrochemical power cell includes an anode with a first current collector and an anode active material deposited on the first current collector. The electrochemical power cell also includes a cathode with a second current collector and a cathode active material deposited on the second current collector. At least one of the first current collector and the second current collector is an electrodeposited aluminum foil.

In another embodiment, a current collector for use in an electrochemical power cell includes a free standing foil made from electrodeposited aluminum.

In yet another embodiment, a method for forming a current collector includes: applying an electrodeposition potential to deposit a metal including aluminum onto an electrodeposition surface located in an electrodeposition bath including ionic aluminum; and delaminating the deposited metallic aluminum from the electrodeposition surface to form a freestanding metal foil.

In another embodiment, a method for forming an electrochemical cell includes: tensioning a current collector, wherein the current collector comprises an electrodeposited aluminum, wherein the current collector has a thickness between about 4 μm and 10 μm, and wherein the current collector has sufficient strength to support the applied tension without tearing; and applying an electroactive material to a surface of the tensioned current collector.

In yet another embodiment, a current collector for use in an electrochemical power cell includes a free standing foil comprising aluminum. A tensile strength of the foil is between about 50 MPa and 1500 MPa.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 is a schematic representation of an electrodeposition process for forming a metal foil;

FIG. 2 is a schematic representation of a calendering process;

FIG. 3 is a schematic representation of a prismatic electrochemical power cell; and

FIG. 4 is a schematic representation of an electrode stack.

### DETAILED DESCRIPTION

Typical aluminum current collectors used in batteries and other electrochemical power cells have thicknesses on the order of about 15 μm to 40 μm. However, in some instances thinner current collectors with thicknesses around 12 μm are used for various applications including, for example, high power electrochemical power cells with multiple thinner current collectors. However, the inventors have recognized that due to inherent material properties, and the processing methods used, typical current collectors possess insufficient strength for use in battery manufacturing processes at thicknesses less than about 10 μm. For example, rolling processes are used on sheets of aluminum to provide thin aluminum current collectors. However, rolled aluminum foils with thickness less than 10 μm have insufficient strength for use in typical battery manufacturing processes. Consequently, these thin aluminum foils may tear, resulting in a final electrode stack with a defect site which may create a potential battery failure, and in more extreme cases, complete stoppage of a manufacturing process due to the aluminum foil completely failing when placed under tension from processes such as cleaning, calendering, and final rolling or assembly. Additionally, in some electrochemical power cells, a current collector, and the associated metal foil, may be placed under further strain as the cell undergoes swelling during charge and discharge cycles.

In view of the above, the inventors have recognized a need for thinner current collectors while providing sufficient strength and conductivity for use in typical electrochemical power cell manufacturing processes and applications. The inventors have also recognized that typical foil manufacturing processes such as rolling become more expensive as the metal foil becomes thinner. Therefore, in some cases it may also be desirable to provide a manufacturing process that is capable of providing a desirable current collector thickness at a reduced, or comparable, price compared to typical manufacturing processes. The inventors have also recognized the need for a current collector with a higher elastic limit, so that the current collectors do not fatigue or plastically deform due to mechanical stresses introduced by swelling of the cell during cell cycling.

In one embodiment, a free standing foil is made from an electrodeposited aluminum or an aluminum alloy metal, which exhibits sufficient strength, ductility, and conductivity for use in electrochemical power cell manufacturing processes and applications. This current collector may be manufactured using any number of different methods. However, in one embodiment, the current collector is manufactured by applying an electrodeposition potential to deposit an aluminum or an aluminum alloy onto an electrodeposition surface located in an electrodeposition bath. The deposited aluminum or aluminum alloy is subsequently delaminated from the electrodeposition as described in more detail below. The resulting foil may then be used as a current collector.

For the purposes of this application, a free standing foil should be understood to describe a thin metallic sheet without electroactive material applied to the surfaces. In other words, freestanding foil describes a bare current collector. In addition, a freestanding foil and/or current collector may be provided in any appropriate form factor. For, example, a freestanding foil current collector may be provided as a roll, a shape, or any other appropriate form factor. Additionally, a freestanding foil may also refer to unpacked materials such as an unrolled current collector, a current collector transported or handled during a manufacturing process, or any other appropriate configuration as the disclosure is not so limited.

The phrase “deposited on” should be understood to describe structures where a layer is both directly deposited on a surface as well as structures where a layer is deposited on a surface with one or more intervening layers. Consequently, in one embodiment, an active material layer may be directly deposited onto a surface of a current collector including a metal foil. Alternatively, in another embodiment, an active material layer may be deposited onto a surface comprising one or more layers, such as a passivation layer or other appropriate layer or coating, located between the metal foil and the deposited active material layer as the disclosure is not so limited.

Depending on the particular embodiment, a current collector may be formed using pure aluminum or a combination of aluminum and one or more additional metals or metalloids. These additional metals may include, but are not limited to, electrodeposited metals or metalloids such as one or more of Sc, Ti, V, Cr, Mn, Fe, Co, Ni, Cu, Y, Zr, Nb, Mo, Tc, Rh, Ru, Ag, Cd, Pt, Pd, Ir, Hf, Ta, W, Re, Os, Li, Na, K, Mg, Be, Ca, Sr, Ba, Ra, Zn, Au, U, Si, Ga, Ge, In, Tl, Sn, Sb, Pb, Bi, B, C, Se and Hg. Depending on the embodiment, the electrodeposited aluminum is a substantially pure metal, or a metal alloy, as the disclosure is not so limited. For example, in one embodiment, the electrodeposited metal is an aluminum alloy including one or more of magnesium and manganese. For example, the alloy may have a magnesium and/or manganese content greater than approximately 0.5 at. %, (atomic percent), 1.0 at. %, 1.5%, 2 at. %, 3 at. %, 4 at. %, 5 at. %, 6 at. %, 7 at. %, 8 at. %, 9 at. %, 10 at. %, 12 at. %, 13 at. %, 14 at. %, 15 at. %, or any other appropriate composition. Correspondingly, the magnesium and/or manganese content may be less than approximately 40 at. %, 30 at. %, 20 at. %, 19 at. %, 18 at. %, 17 at. %, 16 at. %, 15 at. %, 14 at. %, 13 at. %, 12 at. %, 11 at. %, 10 at. %, 9 at. %, 8 at. %, 7 at. %, 6 at. %, 5 at. %, or any other appropriate composition. Combinations of the above ranges are possible (e.g. an alloy composition including between 1 at. % manganese to approximately 20 at. % manganese or between approximately 3 at. % manganese to approximately 12 at. % manganese). Other compositional ranges for the electrodeposited metallic alloy are also possible including the addition of other alloying elements.

While several particular aluminum alloys are noted above, it should be understood that any appropriate pure aluminum and/or aluminum alloy may be selected for use in an electrochemical power cell. For example, a particular current collector for use in an anode or cathode, may be selected to be electrochemically compatible with the corresponding active material to avoid dissolution, or other undesirable side reactions of the current collector, during use. For example, electrodeposited aluminum and certain aluminum alloys may be suitable for use as current collectors in lithium-ion cathode assemblies.

It should be understood that the electrodeposited aluminum and aluminum alloys noted above, may include impurities such as other metallic elements as well as nonmetallic elements. Additionally, the amount of impurities present within an electrodeposited aluminum or aluminum alloy will depend on the manufacturing processes used. However, it should be understood that pure aluminum and aluminum alloys including such impurities are considered to be included in the current disclosure as would be understood by one of skill in the art.

In some cases, the coating (e.g., the first layer and/or the second layer) may have a particular microstructure. For example, in some embodiments, the electrodeposited metal used in a freestanding aluminum or aluminum alloy foil and/or current collector has a nanocrystalline microstructure. As used herein, a “nanocrystalline” structure refers to a structure in which the number-average size of crystalline grains is less than 1 μm. The number-average size of the crystalline grains provides equal statistical weight to each grain and is calculated as the sum of all spherical equivalent grain diameters divided by the total number of grains in a representative volume of the body. Therefore, in some embodiments, a nanocrystalline microstructure has an average grain size that is less than or equal to about 0.5 μm, 0.1 μm, 0.05 μm, 0.02 μm, and/or an amorphous microstructure with no apparent average grain size due to the lack of individual grains and crystal structure. As known in the art, an amorphous structure is a non-crystalline structure characterized by having no long range symmetry in the atomic positions. Examples of amorphous structures include glass, or glass-like structures.

While foils and current collectors with nanocrystalline structures are discussed above, it should be understood that electrodeposited metals having microstructures with average grain sizes that are larger than the nanometer scale are also contemplated. For example, an electrodeposited metal may have an average grain size that is between or equal to about 1 μm and 10 μm, 1 μm and 50 μm, 10 μm and 100 μm, or any other desirable size scale as the disclosure is not so limited.

As noted previously, as the aluminum or aluminum alloy foil used in a current collector becomes thinner, the strength of the base material may be insufficient in these thinner cross-sections to appropriately support the tensile forces present during handling, manufacturing, and use in an electrochemical power cell which may result in tears and/or failures of the current collector. Consequently, in some embodiments, it may be desirable for the material used in a metal foil and/or current collector to have a sufficient intrinsic strength such that it is able to support the mechanical forces applied to current collectors in these various scenarios even in these thinner cross-sections. For example, in one embodiment, the metal foil and/or current collector may be made with an electrodeposited metal exhibiting tensile strengths greater than about 50 MPa, 100 MPa, 150 MPa, 300 MPa, 400MPa, 600 MPa, 900 MPa, 1000 MPa, or any other appropriate tensile strength. Correspondingly, the metal foil and/or current collector may be made with an electrodeposited metal exhibiting tensile strengths that are less than or equal to about 1750 MPa, 1500 MPa, 1000 MPa, 500 MPa, or any other appropriate tensile strength. Various combinations of the above ranges are contemplated including, for example, an electrodeposited aluminum alloy may have a tensile strength between about 150 MPa and 1750 MPa, 300 MPa and 1500 MPa, 400 MPa and 1200MPa or any other desirable combination. In another embodiment, a substantially pure electrodeposited aluminum may have a tensile strength between about 50 MPa and 1500 MPa, 100 MPa and 1500 MPa, 150 MPa and 1500 MPa, or any other combination.

Without wishing to be bound by theory, depending on the specific chemistry used, electrochemical power cells subjected to charge and discharge cycles may undergo significant swelling due to electrochemical reactions and intercalation of active elements into an electrode structure such as lithium into graphite. For larger thickness aluminum or aluminum alloy current collectors, the stresses imposed by the swelling typically is not an issue. However, as noted above for thinner thickness aluminum or aluminum alloy current collectors, on the order of about 10 μm or less, swelling may result in increased stresses and corresponding tearing of a current collector. Further, for some active elements the swelling can be sufficient to cause issues even with thicker foils. Therefore, in some embodiments, it may be desirable to provide an aluminum or aluminum alloy current collector with a combination of an elastic limit and elastic modulus that is capable of elastically accommodating the stresses and strains imposed from swelling of an electrochemical power cell during use without tearing or otherwise failing. For example, in one embodiment, an elastic limit of the electrodeposited metal has an elastic limit that is greater than or equal to about 0.2%, 0.4%, 0.5%, 0.6%, 0.8%, 1.0%, 1.5%, 2.0%, or any other appropriate elastic limit. Additionally, the elastic limit may be less than or equal to about 3%, 2.5%, 2.0%, 1.0%, 0.8%, or any other appropriate elastic limit. Combinations of the above noted elastic limits ranges are possible including, for example, an elastic limit between or equal to about 0.2% and 1.0%. In addition to the elastic limits noted above, an appropriate electrodeposited metal may also exhibit an elastic modulus between or equal to about 63-76 GPa.

Depending on the particular processing parameters used, an electrodeposited aluminum or aluminum alloy metal may also exhibit enhanced ductility, where a metal's ductility may be considered to be the engineering strain applied just prior to fracture. For example, in one embodiment, the electrodeposited metal may have a ductility greater than approximately 2%, 3%, 5%, 10%, 15%, 20%, 25%, 30%, 35%, 40% or any other appropriate ductility. The ductility may also be less than approximately 50%, 40%, 35%, 30%, 25%, 20%, 15%, 10%, or any other appropriate ductility. Combinations of the above ranges are possible (e.g. a ductility between approximately 2% and 50%, 3% and 40%, or 4% and 25%). Other combinations are also contemplated. In one exemplary system, a nanocyrstalline aluminum manganese alloy deposited using a reverse pulse electrodeposition method exhibits a ductility between about 5% and 40% as compared to a direct current electrodeposition method of the alloy exhibiting a larger microstructure which may exhibit a ductility less than about 3% or negligible in some instances as described in International Patent Application No. PCT/US2014/021947 filed on Mar. 7, 2014 and published as WO 2014/159098 which is incorporated herein by reference in its entirety.

In some embodiments, a metal foil comprising an electrodeposited metal corresponding to an aluminum or aluminum alloy manufactured as described herein exhibits an increased hardness as compared to typical aluminum or aluminum alloys. For example, a hardness of the aluminum or aluminum alloy metal may be greater than or equal to about 100 Vickers Hardness Number (VHN), 150 VHN, 200 VHN, or any other appropriate hardness. Correspondingly, the hardness may be less than or equal to about 600 VHN, 550VHN, 500 VHN, 400 VHN, 300 VHN, 200 VHN, and 150 VHN, or any other appropriate hardness Combinations of the above ranges are contemplated, including a hardness between or equal to about 100 VHN to 550 VHN, 100 VHN to 200 VHN, and other possible combinations. While various hardness ranges are described above, it should be noted that other hardnesses both larger than and less than those above are possible as the disclosure is not limited to any particular hardness range of the material used to make a metal foil.

Appropriate electrodeposited metals capable of providing the above noted tensile strengths, ductility, elastic limits, and/or hardness include, but are not limited to, nanocrystalline aluminum and aluminum alloys such as, aluminum manganese alloys and aluminum magnesium alloys. The various compositions and electrodeposition methods associated with these alloys are more completely described in U.S. patent application Ser. No. 12/579,062 filed on Oct. 14, 2009 and published as US 2011/0083967 both of which are incorporated herein by reference in their entirety for all purposes.

Due to the use of doubling in typical rolling processes for producing thin metal foils (i.e., a practice where two sheets of material are rolled at the same time to make rolling a thin foil easier), aluminum or aluminum alloy current collectors typically have a bright side and a dull side. Consequently, it is only possible to control the surface roughness of one side of a typical aluminum or aluminum alloy current collector. Further, the range of surfaces that can be reasonably obtained through a rolling process is also limited. However, in some instances, it may be desirable to control the surface roughness on both sides of the current collector to enhance either adhesion and/or the electrical conductivity between the current collector and electroactive material deposited onto the surfaces of the current collector. Further, in some instances, it may be desirable to control the surface roughness to a tight tolerance and/or a complex topology. In contrast to typical processes, a current collector including an aluminum or aluminum alloy metal foil made using an electrodeposited metal may exhibit a controlled surface roughness on both sides, and this controlled surface roughness can be to very tight tolerance and/or include a complex topology. For example, in one embodiment, a surface roughness of a deposition surface, such as a rotating mandrel, may be selected to provide a desired surface roughness for a side of a metal foil in contact with the deposition surface when deposited thereon. Correspondingly, a surface roughness of the opposing surface of the metal foil facing away from the deposition surface may be controlled using appropriate electrodeposition parameters such as electrodeposition bath composition, electrodeposition bath additives, electrodeposition potentials, electrodeposition pulse parameters, and other appropriate parameters. In view of the above, a metal foil and/or current collector made using an electrodeposited metal may exhibit an average surface roughness (Rₐ) value between about 0.05 μm and 10 μm, 0.05 μm and 5 μm, or 0.05 μm and 2.5 μm. However, other ranges for the Rₐ surface roughness are also contemplated as the disclosure is not limited to any particular surface roughness range.

In some instances, an electrodeposited metal may exhibit one, a combination, all, or none of the above noted properties. Additionally, in some embodiments, electrodeposited metal exhibiting these properties may be a nanocrystalline electrodeposited metal. Further, these properties may be desirable for use with aluminum and aluminum alloy current collectors having a variety of thicknesses. For example, in one embodiment, an electrodeposited aluminum or aluminum alloy metal has a thickness that is greater than or equal to about 0.5 μm, 1 μm, 4 μm, 6 μm, 8 μm, 10 μm, 12 μm, or any other appropriate thickness. Additionally, the thickness may be less than or equal to about 40 μm, 30 μm, 25 μm, 20 μm, 15 μm, 12 μm, 10 μm, 8 μm, 5 μm, 4 μm or any other appropriate thickness. Combinations of the above noted thickness ranges are contemplated including, for example, an aluminum or aluminum alloy metal foil with a thickness that is between about 0.5 μm and 5 μm, 4 μm and 15 μm, 4 μm and 10 μm, as well as other appropriate ranges.

An aluminum or aluminum alloy metal foil for use as a current collector in an electrochemical power cell may have any number of different surface treatments applied for a variety of reasons including passivation and conductivity to name a few. However, unlike typical metal foils that have been subjected to rolling processes and have developed heavy oxide layers, the surfaces of metal foils made using electrodeposited metal may exhibit either substantially no oxide layer, or an oxide layer that is one to several monolayers thick. Consequently, in some embodiments, the oxide layer does not substantially effect conductivity across the oxide layer. This may eliminate the need to perform a cleaning step to remove the oxide layer from the metal foil surfaces prior to other steps such as passivation layer formation and eventual use in an electrochemical power cell. For example, an electrodeposited aluminum based metal foil may be transferred directly from a rinsing and drying step after electrodeposition to one or more passivation steps such as exposure to LiPF₆ to form an aluminum fluoride passivation layer without the need to remove an oxide layer. However, embodiments in which an oxide layer is removed from a metal foil prior to any appropriate formation step are also contemplated as the disclosure is not so limited.

Turning to the figures, the various embodiments of methods manufacture as well as applications and method of use for metal foils, current collectors, and electrochemical power cells are described in more detail. However, it should be understood that the current disclosure should not be limited to only the embodiments described herein. Instead, the various features and methods of the embodiments described herein may be combined in any suitable fashion as the disclosure is not so limited.

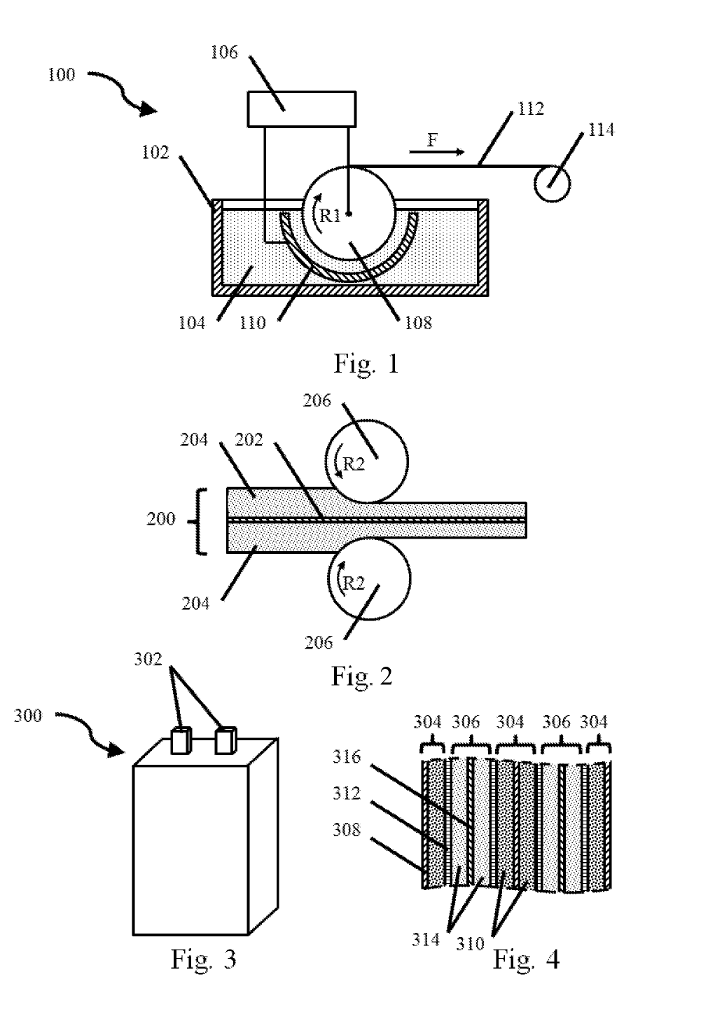

FIG. 1 depicts one embodiment of an electrodeposition system 100 for forming a metal foil includes an electrodeposition bath 102 contained within a container 104. A power source 106 is connected to an electrodeposition surface 108 and a counter electrode 110 that are both at least partially immersed within the electrodeposition bath. In the depicted embodiment, the electrodeposition surface corresponds to a rotating surface such as a rotating mandrel or barrel that is at least partially submerged in the electrodeposition bath and rotated in direction R1. As the electrodeposition surface is rotated, an electrodeposition potential is applied by the power source to both the electrodeposition surface and the counter electrode. This results in metal ions contained within the electrodeposition bath depositing onto the electrodeposition surface. As the electrodeposition surface rotates, a metal is continuously deposited on the electrodeposition surface until it is delaminated to form a freestanding metallic foil 112. The freestanding metallic foil is continuously transferred as it is delaminated from the electrodeposition surface in direction F where it is wound onto a spool 114.

The various properties and dimensions of the metal foil formed using the above noted process, as well as other electrodeposition processes, depend on several electrodeposition parameters. For example, the rotational speed of the electrodeposition surface effects the amount of time metal may be deposited on any given point of the electrodeposition surface prior to being delaminated. Consequently, at a given deposition rate faster rotation speeds correspond to thinner metal foils. Additionally, the applied electrodeposition waveform, potential magnitudes, and electrodeposition bath composition also affect the final thickness and material properties as well. For instance, prior aqueous based electrolyte baths were not appropriate for depositing thin aluminum metal foils because aluminum cannot be deposited from an aqueous plating solution. In contrast, non-aqueous electrodeposition techniques described herein can be used to electrodeposit aluminum metal foils, and these foils exhibit enhanced strengths relative to rolled aluminum foils and are capable of use in electrochemical power cells as well as their manufacturing processes.

Depending on the embodiment, the power source 8 may be used to apply any desired electrodeposition waveform. For example, the electrodeposition waveform may include direct deposition, forward pulses, reverse pulses, rests, combinations of the above, or any other appropriate electrodeposition process. Further, transitions between the different portions of a waveform may either be done using step functions, or gradual transitions may be provided between the different portions of the waveform as the current disclosure is not limited in this fashion. In some embodiments, the electrodeposition waveform includes forward and/or reverse pulses with a preselected current density. For example, the current densities of the forward and reverse pulses may either be the same, the forward pulse may have a greater current density than the reverse pulse, or the reverse pulses may have a greater current density then the forward pulse. Specific ranges of possible current densities and pulse durations are provided below. It should also be understood that any appropriate duration of the forward and reverse pulses may be used as noted in more detail below.

Depending on the embodiment, the current density of either of the pulses may be greater than about 0.1 mA/cm², 1 mA/cm², 5 mA/cm², 10 mA/cm², 20 mA/cm², 50 mA/cm², 100 mA/cm², 250 mA/cm², 500 mA/cm², 1000 mA/cm², 1500 mA/cm², 2000 mA/cm², or any other appropriate current density. Correspondingly, the current density of either of the pulses may be less than about 2500 mA/cm², 2000 mA/cm², 1500 mA/cm², 1000 mA/cm², 600 mA/cm², 500 mA/cm², 250 mA/cm², or any other appropriate current density. Combinations of the above upper and lower ranges of current densities are possible. For example, a current density may be between about 5 mA/cm² and 300 mA/cm², 20 mA/cm² and 600 mA/cm², or any other appropriate combination.

In another related embodiment, the electrodeposition waveform may include forward, reverse pulses, and/or pauses with preselected durations. In embodiments including both reverse and forward pulses, the forward pulse durations and reverse pulse durations may be the same, the forward pulse duration may be greater than the reverse pulse duration, or the reverse pulse duration may be greater than the forward pulse duration. Additionally, in embodiments including one or more pauses between pulses, the pauses may be greater than, less than, or equal to the durations of the pulses. Appropriate durations for the forward pulses, reverse pulses, and/or pauses may be greater than about 0.1 ms, 1 ms, 2 ms, 5 ms, 10 ms, 20 ms, 50 ms, 100 ms, 200 ms, 300 ms, or any other appropriate duration. Correspondingly, appropriate durations for the forward pulses, reverse pulses, and/or pauses may be less than about 1 s, 500 ms, 300 ms, 200 ms, 100 ms, 70 ms, 50 ms, 20 ms, 10 ms, 5 ms, 2 ms, or any other appropriate duration. Combinations of the above upper and lower ranges of the durations are possible (e.g. a forward pulse duration between about 10 ms and 70 ms as well as a reverse pulse duration between about 5 ms and 60 ms). Other combinations are also possible.

As noted above, the electrodeposition bath may include a nonaqueous electrolyte as well as one or more appropriate co-solvents. Depending on the embodiment, the nonaqueous electrolyte includes at least one of an ionic liquid or molten salt with one or more metal ionic species dissolved therein corresponding to the metallic elements for use in a depositing a pure aluminum or aluminum alloy metallic foil as noted above. Appropriate ionic liquid, metal ionic species, and co-solvents are described in more detail below. The metal ionic species present in the bath may be selected for depositing pure metals or alloys as the disclosure is not so limited.

Non-limiting examples of types of metal ionic species dissolved in an electrodeposition bath for depositing an aluminum, or aluminum alloy, include at least metal ionic aluminum. Additionally, when alloys are deposited the an electrodeposition bath may also include one or more metal ionic species of Sc, Ti, V, Cr, Mn, Fe, Co, Ni, Cu, Y, Zr, Nb, Mo, Tc, Rh, Ru, Ag, Cd, Pt, Pd, Jr, Hf, Ta, W, Re, Os, Li, Na, K, Mg, Be, Ca, Sr, Ba, Ra, Zn, Au, U, Si, Ga, Ge, In, Tl, Sn, Sb, Pb, Bi, Hg, and other appropriate elements. In one specific embodiment, the metal ionic species include aluminum and at least one of magnesium and manganese for depositing an aluminum alloy. The metal ionic species may be provided in any suitable amount relative to the total bath composition. Additionally, the metal ionic species may be provided in any appropriate form. For example, metal ions may be provided in the form of an additive such as a salt capable of disassociating within the electrodeposition bath to provide the desired metal ionic species. For example, AlCl₃ might be used in a bath for depositing aluminum or an aluminum alloy. Alternatively, metal ionic species may be added to the electrodeposition bath using an appropriate anode made from a solid form of the desired metal .

As noted above, in some embodiments, the non-aqueous electrolyte bath includes a molten salt. While any appropriate molten salt for depositing a particular metal or metal alloy may be used, in one embodiment, a molten salt including any appropriate combination of chlorides or fluorides of Li, Na, K, Cs, Mg and Ca, containing AlCl₃ or AlF₃ may be used for depositing an aluminum or aluminum alloy. For example, an aluminum bath cryolite such as Na₂AlF₆ may be used. However, other appropriate molten salts, including salts appropriate for depositing different aluminum alloys, may also be used as the disclosure is not so limited.

Those of ordinary skill in the art will be aware of suitable ionic liquids for use in connection with the electrodeposition baths and methods described herein. The term “ionic liquid” as used herein is given its ordinary meaning in the art and refers to a salt in the liquid state. In embodiments where an electrodeposition bath comprises an ionic liquid, this is sometimes referred to as an ionic liquid electrolyte. The ionic liquid electrolyte may optionally comprise other liquid components, for example, a co-solvent, as described herein. An ionic liquid generally includes at least one cation and at least one anion. In some embodiments, the ionic liquid includes an imidazolium, pyridinium, pyridazinium, pyrazinium, oxazolium, triazolium, pyrazolium, pyrrolidinium, piperidinium, tetraalkylammonium or tetraalkylphosphonium salt. In some embodiments, the cation is an imidazolium, a pyridinium, a pyridazinium, a pyrazinium, a oxazolium, a triazolium, or a pyrazolium. In some embodiments, the ionic liquid includes an imidazolium cation. In some embodiments, the anion is a halide. In some embodiments, the ionic liquid comprises a halide anion and/or a tetrahaloaluminate anion. In some embodiments, the ionic liquid includes a chloride anion and/or a tetrachloroaluminate anion. In some embodiments, the ionic liquid comprises tetrachloroaluminate or bis(trifluoromethylsulfonyl)imide. In some embodiments, the ionic liquid includes butylpyridinium, 1-ethyl-3-methylimidazolium [EMIM], 1-butyl-3-methylimidazolium [BMIM], benzyltrimethylammonium, 1-butyl-1-methylpyrrolidinium, 1-ethyl-3-methylimidazolium, or trihexyltetradecylphosphonium. In some embodiments, the ionic liquid comprises 1-ethyl-3-methylimidazolium chloride. In one specific embodiment a chloroaluminate ionic liquid such as [EMIM]Cl/AlCl₃ and/or [BMIM]Cl/AlCl₃ may be used in the electrodeposition bath.

In some embodiments, a co-solvent used in an electrodeposition bath is an organic solvent which may, or may not be, an aromatic solvent. In some embodiments, the co-solvent is selected from the group consisting of toluene, benzene, tetralin (or substituted versions thereof), ortho-xylene, meta-xylene, para-xylene, mesitylene, halogenated benzenes including chlorobenzene and dichlorobenzene, and methylene chloride. In some embodiments, the co-solvent is toluene. The co-solvent may be present in any suitable amount. In some embodiments, the co-solvent is present in an amount between about 1 vol % and 99 vol %, between about 10 vol % and about 90 vol %, between about 20 vol % and about 80 vol %, between about 30 vol % and about 70 vol %, between about 40 vol % and about 60 vol %, between about 45 vol % and about 55 vol %, or about 50 vol % versus the total bath composition. In some embodiments, the co-solvent is present in an amount greater than about 10 vol %, 25 vol %, 50 vol %, 55 vol %, 60 vol %, 65 vol %, 70 vol %, 80 vol %, or 90 vol % versus the total bath composition. In some embodiments, the co-solvent and the ionic liquid form a homogenous solution.

The specific co-solvent to be used may be selected based upon any number of desired characteristics including, for example, viscosity, conductivity, boiling point, and other characteristics as would be apparent to one of ordinary skill in the art.

One or more co-solvents may be mixed with the ionic liquid in any desired ratio to provide the desired electrodeposition bath properties. For example, in some embodiments, the co-solvent may also be selected based on its boiling point. In some cases, a higher boiling point co-solvent may be employed as it can reduce the amount and/or rate of evaporation from the electrolyte, and thus, may aid in stabilizing the process. Those of ordinary skill in the art will be aware of the boiling points of the co-solvents described herein (e.g., toluene, 111° C.; methylene chloride, 41° C.; 1,2-dichlorobenzene, 181° C.; o-xylene, 144° C.; and mesitylene, 165° C.). While specific co-solvents and their boiling points are listed above, other co-solvents are also possible. Furthermore, in some embodiments the co-solvent is selected based upon multiple criteria including, but not limited to, conductivity, boiling point, and viscosity of the resulting electrodeposition bath.

FIG. 2 depicts one embodiment of an anode or cathode assembly 200 being formed using a current collector including a metal foil 202 manufactured using the above described method, or any other appropriate method, as well as active material 202 deposited on one, or both sides, of the metal foil. As depicted in the figure, the active material is initially in an uncompressed state held onto the metal foil using an appropriate binder. To aid densification of the active material, an anode or cathode assembly may undergo a calendering process where it is passed through a compressive device such as a pair of rollers 206 rotating in directions R2 which both compress the assembly and help to pull it through the manufacturing process. Depending on the particular processing method, heat may be applied either before, concurrently, and/or after the calendering process. After the calendering process, the assembly has a more densified layer of active material attached to one, or both sides, of the metal foil included in the current collector.

FIG. 3 presents one possible use for an electrode assembly. As shown in the figure, in one embodiment, the metal foils described herein are used as a current collector in an electrochemical power cell 300 containing two or more electrical leads 302. Depending on the particular application the electrochemical power cell may be a capacitor, ultracapacitor, battery, or other similar device. Additionally, while a rectangular prismatic cell has been depicted, the electrochemical power cell and associated current collector may be sized and shaped for any appropriate form factor including, but not limited to, other prismatic cell shapes, pouch cells, jelly roll cells, and coin cells to name a few.

In one embodiment, an electrochemical power cell, using the current collectors and metal foils described herein, is a high power cell where a plurality of relatively thin current collectors are typically used to enable the extraction of higher powers while also maintaining a sufficient energy density. One such arrangement is shown in FIG. 4 where a plurality of anodes 304 and a plurality of cathodes 306 are alternatingly arranged with separators 312 disposed between adjacent anodes and cathodes within the interior of the electrochemical power cell. Each of the anodes 304 include an anode current collector 308 with anode active material 310 adhered to one or both sides of the current collector. Similarly, each of the cathodes 306 includes a cathode current collector 316 with cathode active material 314 adhered to one or both sides of the current collector depending on their position within a stack, and the particular type of cell being used. Depending on the particular embodiment, the anode current collector and/or cathode current collector may be manufactured using the free standing metal foils described herein permitting the use of thinner current collectors which may enable either the use of more electrodes for higher power while maintaining a desired energy density of the cell or the inclusion of more active material to increase an energy density of the cell. However, other benefits and uses are also possible, and the current disclosure should not be limited to only these applications.

### EXAMPLE

### Rolled Microstructure v. Electrodeposited Microstructure

Without wishing to be bound by theory, it is possible to distinguish the microstructure an electrodeposited metal foil from a metal foil manufactured using a typical rolling process. For example, a rolled metal foil includes a microstructure where the grain structure of grains has an elongated structure oriented in a particular direction, usually the machine direction, due to the grains elongating during a rolling process. In contrast, a metal foil that has been electrodeposited has a more uniform microstructure that does not substantially show any particular direction of orientation for the grain structure.

### Example

### Electrodeposited Metal Foil Properties

A number of alloys have been made to date using the ionic liquids described herein. Several ranges of plating parameters, compositions, and material properties that have been obtained are provided below.

TABLE I

| Composition: | 0 to 20 at. %-Mn | |
|---|---|---|
| Plating Temp.: | 35-80° | C. |
| Current density: | 5 to 300 | mA/cm² |
| Pulse duration: | 5 to 100 | ms |
| Tensile strength: | 300-1300 | MPa |
| Elongation: | 1-15% | |
| Elastic Modulus: | 70 | GPa |
| Hardness: | 100-500 | HV |

| | |
|---|---|
| Microstructure: | Amorphous (0 nm) up to 5 um |

While several embodiments of have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present disclosure. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present disclosure is/are used. Those skilled in the art will recognize, or be able to ascertain using no more than routine experimentation, many equivalents to the specific embodiments of the disclosure described herein. It is, therefore, to be understood that the foregoing embodiments are presented by way of example only and that, within the scope of the appended claims and equivalents thereto, the disclosure may be practiced otherwise than as specifically described and claimed. The present disclosure is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

What is claimed is:

1. An electrochemical power cell comprising:
an anode including a first current collector and an anode active material deposited on the first current collector;
a cathode including a second current collector and a cathode active material deposited on the second current collector, wherein at least one of the first current collector and the second current collector comprises an electrodeposited aluminum foil.

2. The electrochemical power cell of claim 1, wherein the electrodeposited aluminum foil comprises an aluminum alloy.

3. The electrochemical power cell of claim 2, wherein the aluminum alloy comprises at least one of manganese and magnesium.

4. The electrochemical power cell of claim 3, wherein the aluminum alloy comprises between about 0.5 atomic percent and 25 atomic percent of manganese and magnesium.

5. The electrochemical power cell of claim 1, wherein a tensile strength of the electrodeposited aluminum foil is between about 150 MPa and 1500 MPa.

6. The electrochemical power cell of claim 1, wherein the electrodeposited aluminum foil comprises substantially pure aluminum, and wherein a tensile strength of the electrodeposited aluminum foil is between about 50 MPa and 1500 MPa.

7. The electrochemical power cell of claim 1, wherein an elastic limit of the electrodeposited aluminum foil is greater than about 0.4% and less than about 3.0% .

8. The electrochemical power cell of claim 1, wherein the ductility of the electrodeposited aluminum foil is between about 2% and 50%.

9. The electrochemical power cell of claim 1, wherein the hardness of the electrodeposited aluminum foil is between about 100 VHN and 550 VHN.

10. The electrochemical power cell of claim 1, wherein a Rₐ surface roughness of at least two sides of the electrodeposited aluminum foil is between about 0.5 μm and 5 μm.

11. The electrochemical power cell of claim 1, wherein the electrodeposited aluminum foil has a nanocrystalline microstructure.

12. The electrochemical power cell of claim 1, wherein the electrodeposited aluminum foil has an average grain size between or equal to about 1 tm and 100 μm.

13. The electrochemical power cell of claim 1, wherein a thickness of the electrodeposited aluminum foil is between about 4 tm and 20 μm.

14. A current collector for use in an electrochemical power cell comprising:
a free standing foil comprising electrodeposited aluminum.

15. The current collector of claim 14, wherein the electrodeposited aluminum comprises an aluminum alloy.

16. The current collector of claim 15, wherein the aluminum alloy comprises at least one of manganese and magnesium.

17. The current collector of claim 16, wherein the aluminum alloy comprises between about 0.5 atomic percent and 25 atomic percent of manganese and magnesium.

18-26. (canceled)

27. A method for forming a current collector, the method comprising:
applying an electrodeposition potential to deposit a metal including aluminum onto an electrodeposition surface located in an electrodeposition bath including ionic aluminum; and
delaminating the deposited metallic aluminum from the electrodeposition surface to form a freestanding metal foil.

28-35. (canceled)

36. A method for forming an electrochemical cell, the method comprising:
tensioning a current collector, wherein the current collector comprises an electrodeposited aluminum, wherein the current collector has a thickness between about 4 μm and 10 μm, and wherein the current collector has sufficient strength to support the applied tension without tearing;
and applying an electroactive material to a surface of the tensioned current collector.

37-42. (canceled)

43. A current collector for use in an electrochemical power cell comprising:
a free standing foil comprising aluminum, wherein a tensile strength of the foil is between about 50 MPa and 1500 MPa.

44-55. (canceled)
